(19) United States
(12) Patent Application Publication
(10) Pub. No.: US 2020/0265404 A1
(43) Pub. Date: Aug. 20, 2020

(54) POINT OF SALE SYSTEM AND COMMODITY ACCOUNTING PROCESSING METHOD

(71) Applicant: TOSHIBA TEC KABUSHIKI KAISHA, Tokyo (JP)

(72) Inventor: Ryuji KOMORI, Izu Shizuoka (JP)

(73) Assignee: TOSHIBA TEC KABUSHIKI KAISHA, Tokyo (JP)

(21) Appl. No.: 16/689,984

(22) Filed: Nov. 20, 2019

(30) Foreign Application Priority Data
Feb. 19, 2019 (JP) 2019-027240
Sep. 20, 2019 (JP) 2019-171736

(51) Int. Cl. G06Q 20/20; G07G 1/00

(52) U.S. Cl. CPC G06Q 20/208; G07G 1/009; G06Q 20/209

(57) ABSTRACT

A POS system includes a POS register configured to read a commodity identification code and first amount information from a tag attached to a commodity. A commodity master database stores the commodity identification code and associated second amount information. The POS register includes an accounting processor configured to perform accounting processing based on the first amount information in the event the second amount information cannot be acquired from the commodity master database. When the first amount information is not previously stored in the commodity master database, the commodity master database stores the first amount information in association with the commodity identification code responsive to reading the first amount information from the tag.

### CROSS-REFERENCE TO RELATED APPLICATIONS

This application is based upon and claims the benefit of priority from Japanese Patent Application No. 2019-027240, filed Feb. 19, 2019, and Japanese Patent Application No. 2019-171736, filed Sep. 20, 2019, the entire contents of which are incorporated herein by reference.

### FIELD

Embodiments described herein relate generally to a Point-of-Sale (POS) system and a commodity accounting processing method.

### BACKGROUND

There is a POS terminal that reads, with a barcode reader, a barcode attached to a commodity and performs accounting processing (settlement processing). An RFID (Radio Frequency Identification) tag is sometimes used instead of the barcode.

First, the POS terminal reads, with a code reader, a barcode or an RFID tag attached to a commodity. Then, the POS terminal instructs, based on a commodity identification code included in the barcode or the like, a host computer to search through a data file (a commodity master database) and acquire a price and the like registered in advance in association with the commodity identification code.

The POS terminal performs such processing for each commodity and registers the acquired price and the like in a memory as sales data. The POS terminal calculates an amount billed of a commercial transaction based on sales data of the commodity registered in the memory.

If a commodity identification code (or a price associated with the commodity identification code) is not registered in the commodity master database or communication between the POS terminal and the host computer is interrupted, the POS terminal cannot perform the settlement processing.

### DESCRIPTION OF THE DRAWINGS

FIG. 1 is a schematic diagram illustrating a POS system according to some embodiments;

FIG. 2 is a block diagram illustrating a main hardware configuration of the POS system according to some embodiments;

FIG. 3A is a diagram illustrating commodity information stored in a commodity master database according to some embodiments;

FIG. 3B is a diagram illustrating a code system of an RFID tag according to some embodiments;

FIG. 4 is a flowchart illustrating a commodity accounting processing method according to some embodiments; and

FIG. 5 is a flowchart illustrating a commodity accounting processing method according to some embodiments.

### DETAILED DESCRIPTION

An object of embodiments is to provide a POS system and a commodity accounting processing method that can perform accounting processing without delay even if a price and the like cannot be acquired from a commodity master database.

A POS system in an exemplary embodiment includes a POS register configured to read a commodity identification code and first amount information from a tag attached to a commodity; and a commodity master database in which the commodity identification code and second amount information associated with the commodity identification code are registered. The POS register includes an accounting processing section configured to perform accounting processing based on the first amount information if the second amount information cannot be acquired from the commodity master database based on the commodity identification code.

The POS system in the embodiment may cause the commodity master database to store the first amount information in association with the commodity identification code.

In the POS system in the embodiment, the first amount information may be stored in an undefined area or a user area of the tag.

A POS system in another embodiment includes a POS register configured to read a commodity identification code and first amount information from a tag attached to a commodity; and a commodity master database in which the commodity identification code and second amount information associated with the commodity identification code are registered. The POS register includes an accounting processing section configured to, if the second amount information can be acquired from the commodity master database based on the commodity identification code, compare the first amount information and the second amount information and perform accounting processing based on one of the first amount information and the second amount information.

A commodity accounting processing method in another embodiment includes: causing a tag to retain a commodity identification code and first amount information and attaching the tag to a commodity; a POS register reading the commodity identification code and the first amount information from the tag; and the POS register performing accounting processing based on the first amount information if second amount information associated with the commodity identification code cannot be acquired from the commodity master database.

A POS system 1 and a commodity accounting processing method in an embodiment are explained below with reference to the drawings. In the drawings, the same components are denoted by the same reference numerals and signs.

POS System

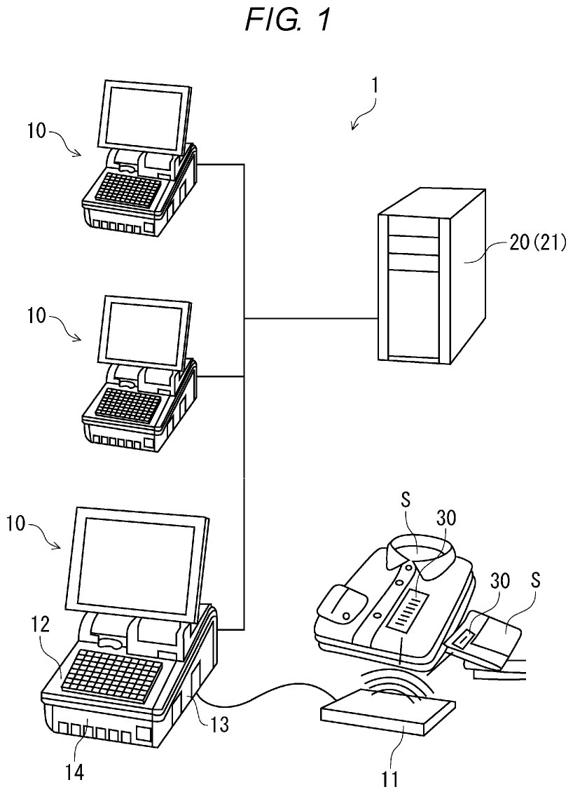

FIG. 1 is a schematic diagram illustrating a POS system 1 according to one embodiment.

The POS system 1 includes a POS register 10 and a commodity registration server 20. The POS system 1 performs accounting processing using RFID tags 30 attached to commodities S.

The POS register (terminal) 10 is an apparatus that performs accounting processing of commodities purchased by a customer in a store. A plurality of POS registers 10 are sometimes disposed in a single store.

The POS register 10 includes a tag reader (tag scanner) 11, a register main body 12, a communication section (communication interface) 13, and a cash drawer 14.

The tag reader 11 is a device that reads (scans) a commodity identification code and the like from the RFID tag 30.

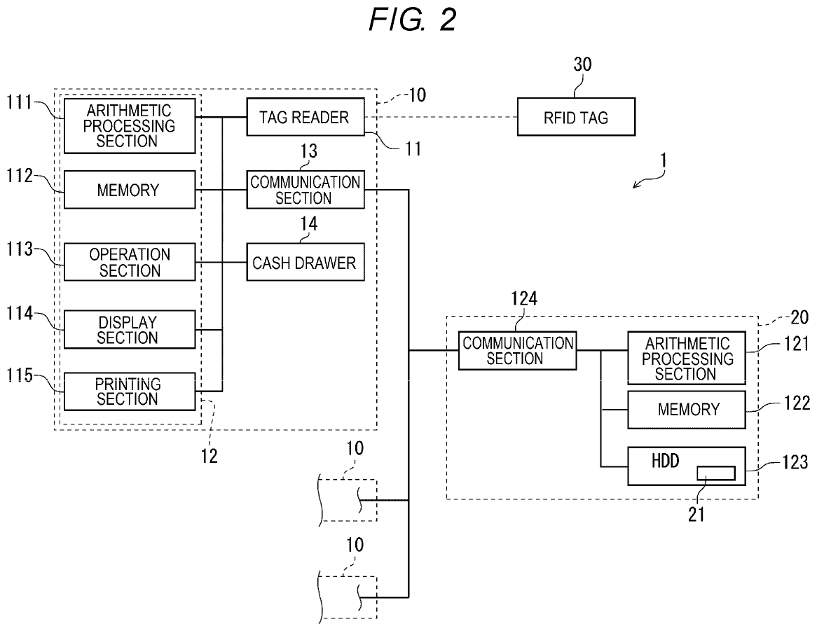

FIG. 2 is a block diagram illustrating a main hardware configuration of the POS system 1 according to some embodiments. The register main body 12 includes an arithmetic processing section (processor) 111, a memory 112, an operation section (operation interface or panel) 113, a display section (display) 114, and a printing section (printer) 115 and, for example, calculates and stores sales amounts of commodities.

The arithmetic processing section (an accounting processing section or accounting processor) 111 collectively controls the POS register 10. The memory 112 stores various kinds of information. The operation section 113 receives an input from an operator of the POS register 10. The display section 114 displays, for example, information such as commodity prices. The printing section 115 prints a receipt or the like.

The communication section 13 is connected to the commodity registration server 20 via an electronic communication line such as a LAN or the Internet.

The cash drawer 14 stores bills and coins.

The commodity registration server 20 is a host computer and is connected to POS registers 10 via an electronic communication line such as a LAN. The commodity registration server 20 includes an arithmetic processing section 121, a memory 122, a hard disk 123, and a communication section 124.

The hard disk 123 includes a commodity master database 21. Information (article information) concerning commodities placed in the store is stored in the commodity master database 21.

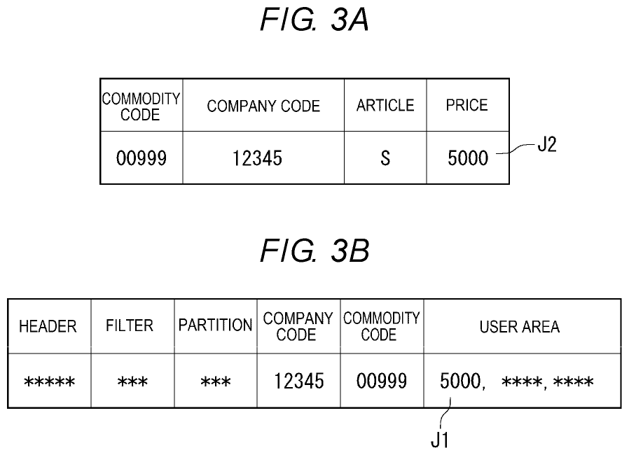

FIG. 3A is a diagram illustrating commodity information of a commodity master database 21.

FIG. 3B is a diagram illustrating a code system of an RFID tag 30. In some embodiments, as illustrated in FIGS. 3A-B, the article information includes a commodity code, a company code, an article, and second amount information J2. For example, “5000” is stored in the second amount information J2 of the article information.

The RFID tags 30 are respectively attached to the commodities S placed in the store one by one. The commodities S are, for example, clothes. Commodity identification codes, prices (first amount information J1), and the like of the commodities S, to which the RFID tags 30 are attached, are stored in advance in the RFID tags 30 together with IDs unique to the tags.

In this way, in principle, the same information is respectively registered (stored) in the commodity master database 21 of the commodity registration server 20 and the RFID tags 30. Commodity identification codes and amount information (the second amount information J2 and the first amount information J1) are respectively registered (stored) in the commodity master database 21 and the RFID tags 30. A commodity identification code is a unique code allocated to each of types of commodities.

The amount information (the second amount information J2 and the first amount information J1) is a unit price, cost, a sales price, and the like.

Tax information, commodity information and commodity attributes, other various kinds of classification information, and the like may be stored in the commodity master database 21 of the commodity registration server 20 and the RFID tag 30 together with the identification codes and the amount information (the second amount information J2 and the first amount information J1).

The tax information is information concerning types of taxes (a consumption tax and the like) and taxation methods (tax-exclusive pricing and tax-inclusive pricing).

The commodity information and the commodity attributes are information such as commodity names and characteristics of the commodities.

The other various kinds of classification information are, for example, price discount prohibition classifications, electronic money payment classifications, and tax free classifications.

The code system of the RFID tag 30 is further illustrated in FIG. 3B. For example, the RFID contains 96 bits that are defined as follows in EPCglobal. Leading 8 bits are a header, the following 3 bits are a filter, and the next 3 bits are a partition. A company code and a commodity identification code are stored in the following 44 bits. Among the 44 bits, between 20 and 40 bits can be allocated to the company code and between 4 and 24 bits can be allocated to the commodity identification code.

The remaining 38 bits are a user area. Commodity information is stored in the user area. The commodity information includes the first amount information J1, the tax information, the commodity information and the commodity attributes, and the other various kinds of classification information. For example, “5000” is stored in the head of the user area as the first amount information J1.

However, if an undefined area is present in the code system of the RFID tag 30, the first amount information J1 and the like may be stored in the undefined area.

Commodity Accounting Processing Method

The commodity accounting processing method in the embodiment is explained.

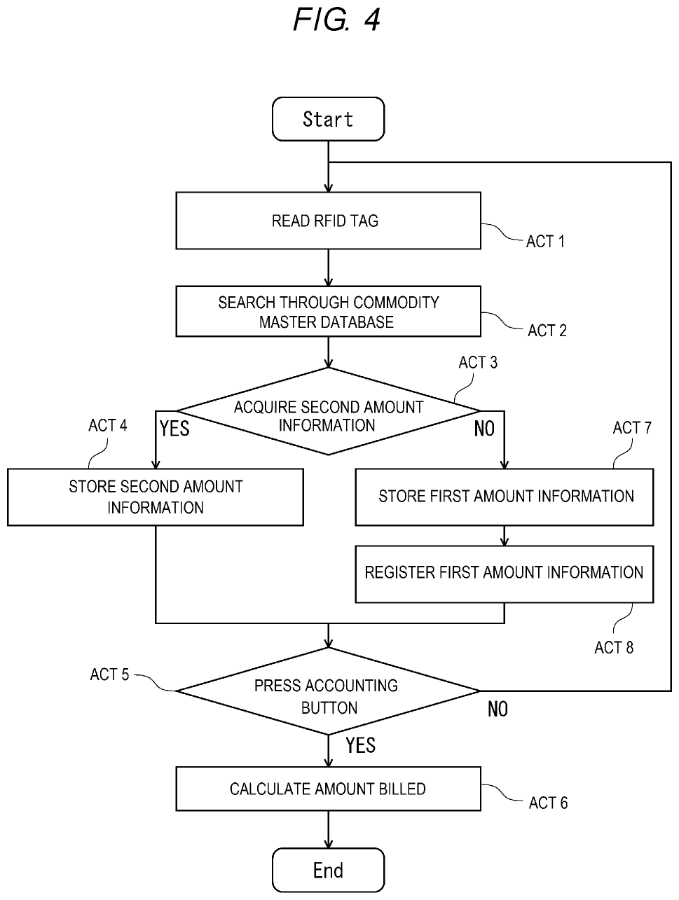

FIG. 4 is a flowchart illustrating the commodity accounting processing method according to an exemplary embodiment.

As a premise, a commodity identification code and the first amount information J1 concerning the commodity S is retained in the RFID tag 30. The RFID tag 30 is attached to the commodity S.

If performing accounting of the commodity S, the POS register 10 reads, with the tag reader 11, the identification code and the first amount information J1 from the RFID tag 30 (Act 1).

Subsequently, the POS register 10 transmits the commodity identification code to the commodity registration server 20 via the communication section 13. The POS register 10 instructs the commodity registration server 20 to search through the commodity master database 21.

Subsequently, the commodity registration server 20 searches through the commodity master database 21 based on the commodity identification code (Act 2).

If acquiring the second amount information J2 linked to the commodity identification code (Yes in Act 3), the commodity registration server 20 returns the second amount information J2 (a price) to the POS register 10. The POS register 10 stores (registers) the second amount information J2 in the memory 112 and creates sales data (Act 4).

Thereafter, the POS register 10 determines whether an accounting button (not illustrated) of the operation section 113 is pressed (Act 5).

If the accounting button is not pressed (No in Act 5), the POS register 10 returns to the reading of the RFID tag 30 (Act 3).

On the other hand, if the accounting button (not illustrated) is pressed (Yes in Act 5), since registration of all accounting target commodities is completed, the POS register 10 calculates an amount billed of a commercial transaction based on sales data (Act 6).

Consequently, the amount billed is displayed on the display section 114. If receiving money, a credit card, or the like from a customer, an operator operates the operation section 113, opens and closes the cash drawer 14, and causes the printing section 115 to output a receipt.

The accounting processing is completed in this way.

In the past, if the commodity identification code of the commodity S is not registered in the commodity master database 21 of the commodity registration server 20, the processing of the POS register 10 is delayed. That is, the accounting processing of the commodity S is disabled. Similarly, the accounting processing of the commodity S is also disabled if communication between the commodity registration server 20 and the POS register 10 is interrupted.

In such a case, registration of the commodity identification code of the commodity S in the commodity master database 21 of the commodity registration server 20 is necessary. That is, the accounting processing of the commodity S is delayed until the commodity identification code of the commodity S is registered in the commodity master database 21.

However, in the POS system 1, even if the commodity identification code of the commodity S is not registered in the commodity master database 21, the accounting processing of the commodity S remains possible. This is due to the POS register 10 reading the commodity identification code and the first amount information J1 from the RFID tag 30.

That is, if the second amount information J2 cannot be acquired in Act 3 (No in Act 3), the POS register 10 stores amount information read from the RFID tag 30 in the memory 112 and creates sales data (Act 7).

Subsequently, the POS register 10 transmits the amount information read from the RFID tag 30 to the commodity registration server 20 and causes the commodity registration server 20 to register (or overwrite and save) the amount information in the commodity master database 21 (Act 8). Thereafter, the POS register 10 proceeds to Act 5.

That is, the POS register 10 performs, ex post facto, registration of the commodity identification code of the commodity S in the commodity master database 21 of the commodity registration server 20. If the communication between the POS register 10 and the commodity registration server 20 is interrupted, the POS register 10 registers the commodity information of the commodity S in the commodity master database 21 after the communication is restored.

In this way, in the POS system 1, the accounting processing of the commodity S is not delayed and processing (stagnation avoidance processing) is smoothly performed.

The POS system 1 registers the first amount information J1 read from the RFID tag 30 in the commodity master database 21 of the commodity registration server 20. Therefore, the POS system 1 prevents the stagnation avoidance processing from being performed multiple times. For example, if a plurality of POS registers 10 are present in the store, a first POS register 10 can prevent the stagnation avoidance processing from being performed at a second POS register 10. That is, the POS system 1 normalizes the stagnation avoidance processing.

The stagnation avoidance processing is performed in the same manner if the commodity identification code of the commodity S is registered in the commodity master database 21 but the second amount information J2 linked to the commodity identification code is not registered in the commodity master database 21.

The stagnation avoidance processing is performed in the same manner if the communication (connection) between the POS register 10 and the commodity registration server 20 is interrupted. That is, if the second amount information J2 cannot be acquired from the commodity master database 21, the accounting processing (the stagnation avoidance processing) based on the first amount information J1 read from the RFID tag 30 is performed.

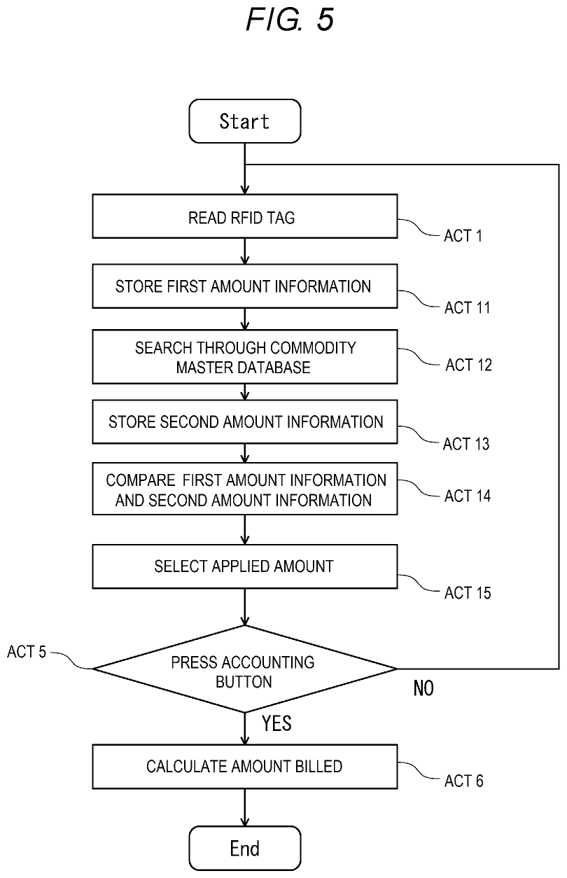

FIG. 5 is a flowchart illustrating a commodity accounting processing method according to an exemplary embodiment.

In the embodiment explained above, the accounting processing (the stagnation avoidance processing) based on the first amount information J1 read from the RFID tag 30 is performed if the second amount information J2 cannot be acquired from the commodity master database 21.

On the other hand, in this embodiment, the accounting processing based on the first amount information J1 read from the RFID tag 30 is performed even if the second amount information J2 can be acquired from the commodity master database 21.

That is, after Act 1, the POS register 10 stores the commodity identification code read from the RFID tag 30 and the first amount information J1 in the memory 112 (Act 11).

Subsequently, the POS register 10 transmits the commodity identification code to the commodity registration server 20 via the communication section 13. The POS register 10 instructs the commodity registration server 20 to query the commodity master database 21.

Subsequently, the commodity registration server 20 queries the commodity master database 21 based on the commodity identification code (Act 12).

If acquiring the second amount information J2 linked to the commodity identification code, the commodity registration server 20 returns the second amount information J2 to the POS register 10. The POS register 10 stores the second amount information J2 in the memory 112 (Act 13).

The arithmetic processing section 111 of the POS register 10 compares the first amount information J1 read from the RFID tag 30 and the second amount information J2 acquired from the commodity master database 21 (Act 14).

The arithmetic processing section 111 selects (applies) amount information indicating a lower sales price and registers the amount information in the memory 112 as sales data (Act 15). That is, the arithmetic processing section 111 selects the lower of the first amount information J1 and the second amount information J2 as an applied amount.

Thereafter, the accounting processing is completed through Acts 5 and 6 of the method of FIG. 4.

The first amount information J1 and the second amount information J2 may be the same or different. If the first and second amount information J1, J2 indicate the same amount in Act 15 (that is, if the first amount information J1 and the second amount information J2 are identical), the arithmetic processing section 111 compares the tax information, the commodity information and the commodity attributes, the other various kinds of classification information, and the like. If one amount information has, for example, discount information, the arithmetic processing section 111 selects the amount information and performs the accounting processing. If the information such as the tax information is also the same, the arithmetic processing section 111 may select either the first amount information J1 or the second amount information J2.

If registration date and times are recorded in registration information of the first amount information J1 and the second amount information J2, the arithmetic processing section 111 may select, as the applied amount, the first amount information J1 or the second amount information J2 having the later registration date and time.

If registrant information is recorded in the registration information of the first amount information J1 and the second amount information J2, the arithmetic processing section 111 may select amount information registered by a person having a higher management authority such as a store manager.

As explained above, in the POS system 1 and the commodity accounting processing method in the embodiment, even if the second amount information J2 cannot be acquired from the commodity master database 21 of the commodity registration server 20, since the first amount information J1 is stored in advance in the RFID tag 30 attached to the commodity S, it is possible to perform the accounting processing without delay.

The POS register 10 causes the commodity registration server 20 to register (or overwrite and save) the first amount information J1 read from the RFID tag 30 in the commodity master database 21. Consequently, it is possible to prevent the stagnation avoidance processing from being repeated in the other POS registers 10 of the store.

Since the RFID tag 30 includes the undefined area or the user area, it is possible to surely store the first amount information J1 and the like in this area.

In the POS system 1 and the commodity accounting processing method in the other embodiment, the second amount information J2 acquired from the commodity master database 21 of the commodity registration server 20 and the first amount information J1 read from the RFID tag 30 are compared and the accounting processing is performed using the second amount information J2 or the first amount information J1. Consequently, it is possible to perform more appropriate accounting processing.

In some embodiments, the operator operates the POS register 10. However, the POS register 10 is not limited to this. The POS register 10 may be a self-type POS terminal.

In the above explanation, the commodity master database 21 of the commodity registration server 20 is searched through to acquire the second amount information J2 linked to the commodity identification code. However, acquisition of the second amount information J2 is not limited to this.

In a large store, a franchise chain, or the like, speedup of the accounting processing is achieved by causing the memory 112 of the POS register 10 to store the commodity master database 21. In such a case, the commodity master database 21 stored in the memory 112 may be queried to acquire the second amount information J2 linked to the commodity identification code.

If the first amount information J1 is applied and the accounting processing is performed because the second amount information J2 is not registered in the commodity master database 21 of the commodity registration server 20, a notification containing information concerning the accounting processing may be generated. Attention of the administrator of the store is called to a registration failure of a sold commodity in the commodity master database 21.

In the above explanation, the RFID tag 30 is used. However, another information identifier (an information carrier) such as a QR code (registered trademark) may be used instead of the RFID tag 30.

The commercial transaction may not involve sale and purchase of a commodity. For example, the embodiment can also be applied to a settlement apparatus that performs settlement of a price generated for service provision such as a usage fee of a facility or a rental fee of a lending article.

The embodiments are presented as examples and are not intended to limit the scope of the invention. These new embodiments can be carried out in other various forms. Various omissions, replacements, and changes can be made in a range not departing from the gist of the invention. These embodiments and modifications of the embodiments are included in the scope and the gist of the invention and included in the inventions described in the claims and the scope of equivalents of the inventions.

What is claimed is:

1. A point-of-sale (POS) system, the system comprising:
a POS register comprising an accounting processor,
wherein the POS register is configured to:
scan a tag attached to a commodity; and
read a commodity identification code and first amount information from the tag; and
a commodity master database configured to store the commodity identification code and associated second amount information,
wherein the accounting processor is configured to perform accounting processing based on the first amount information responsive to determining the second amount information cannot be acquired from the commodity master database based on the commodity identification code.

2. The system according to claim 1, wherein the commodity master database is configured to store the first amount information as the second amount information in association with the commodity identification code responsive to reading the first amount information from the tag.

3. The system according to claim 1, wherein the first amount information is stored in an undefined area or a user area of the tag.

4. The system according to claim 3, wherein the tag attached to the commodity comprises a Radio-Frequency Identification (RFID) tag.

5. The system according to claim 3, wherein the tag attached to the commodity comprises a Quick Response (QR) barcode tag.

6. A point-of-sale (POS) system, comprising:
a POS register comprising an accounting processor,
wherein the POS register is configured to:
scan a tag attached to a commodity; and
read a commodity identification code and first amount information from the tag; and
a memory configured to store a commodity master database, the commodity master database being configured to store the commodity identification code and associated second amount information,
wherein the accounting processor is configured to:
receive, at a communication interface, the second amount information from the commodity master database;
receive, at the communication interface, the first amount information from the POS register;
compare the first amount information and the second amount information; and
perform accounting processing based on one of the first amount information or the second amount information.

7. The system according to claim 6, wherein the first amount information and the second amount information are identical.

8. The system according to claim 6, wherein the first amount information and the second amount information are different.

9. The system according to claim 8, wherein the accounting processor is configured to compare the first amount information and the second amount information to determine a lower amount of the two amounts.

10. The system according to claim 8, wherein the accounting processing section is configured to:
determine a first time at which the first amount information was stored in the tag attached to the commodity;
determine a second time at which the second amount information was stored in the commodity master database;
compare the first time and the second time;
determine which time occurred later; and
select the amount information corresponding to the determined later time.

11. The system according to claim 6, wherein the tag attached to the commodity comprises a Radio-Frequency Identification (RFID) tag.

12. The system according to claim 6, wherein the tag attached to the commodity comprises a Quick Response (QR) barcode tag.

13. A method for commodity accounting processing, the method comprising:
storing a commodity identification code and first amount information on a tag and attaching the tag to a commodity;
scanning, at a POS register, the tag attached to the commodity;
reading, at the POS register, the commodity identification code and the first amount information from the tag;
querying, at the POS register, a commodity master database for second amount information associated with the commodity identification code; and
performing accounting processing based on the first amount information when the second amount information associated with the commodity identification code cannot be acquired from the commodity master database.

14. The method according to claim 13, wherein the tag attached to the commodity comprises a Radio-Frequency Identification (RFID) tag.

15. The method according to claim 13, wherein the tag attached to the commodity comprises a Quick Response (QR) barcode tag.

16. The method according to claim 13, further comprising storing, in the commodity master database, the first amount information as the second amount information in association with the commodity identification code, responsive to reading the first amount information from the tag.
